(19) United States
(12) Patent Application Publication
(10) Pub. No.: US 2025/0078147 A1
(43) Pub. Date: Mar. 6, 2025

(54) DATA INTERACTION METHOD AND APPARATUS, AND ELECTRONIC DEVICE AND STORAGE MEDIUM

(71) Applicant: Beijing Zitiao Network Technology Co., Ltd., Beijing (CN)

(72) Inventors: Yepeng CHEN, Beijing (CN); Yi CHEN, Beijing (CN); Chao ZHOU, Beijing (CN); Yipeng HAO, Beijing (CN); Ang LIU, Beijing (CN)

(21) Appl. No.: 18/571,122

(22) PCT Filed: Aug. 23, 2022
(86) PCT No.: PCT/CN2022/114299

§ 371 Date: Dec. 15, 2023

(30) Foreign Application Priority Data
Sep. 7, 2021 (CN) 202111045913.1

(51) Int. Cl. G06Q 30/0601

(52) U.S. Cl. CPC G06Q 30/0643; G06Q 30/0633

(57) ABSTRACT

The application discloses a data interaction method and apparatus, electronic device and storage medium. The method includes: in response to a triggering operation on collection controls correspondingly associated with at least two articles, adding the at least two articles to a collection list, the collection controls being displayed on a video playing page; in response to a triggering operation of entering the collection list, starting a terminal camera, so as to enter a try-on page, a user target part shot by the camera being displayed in the try-on page; and in response to a first triggering operation on a try-on control associated with a first article, wearing a first model of the first article on the target part, wherein the try-on control is displayed in the try-on page, and the first triggering operation is used for determining to select the first article from the at least two articles.

This application claims priority to Chinese Patent Application 202111045913.1, entitled “Data interaction method and device, electronic equipment and storage medium” filed on Sep. 7, 2021, which is incorporated in this application by reference in its entirety.

### TECHNICAL FIELD

The present disclosure relates to the technical field of information, and particularly relates to a data interaction method and apparatus, an electronic device and a storage medium.

### BACKGROUND

With the rapid development of mobile terminal technology and mobile network technology, shopping online anytime and anywhere has become a trend.

However, when users purchase clothing or shoes online, they cannot see the try-on effect. In response to this issue, some shopping malls have set up AR (Augmented Reality) try-on function, where users can perform AR try-on to experience the try-on effect.

However, existing technologies have the problem of cumbersome operation and low efficiency while switching and trying on multiple clothes or shoes.

### SUMMARY

In order to solve or at least partially solve the technical problem above, an embodiment of the present disclosure provides a data interaction method and apparatus, an electronic device and a storage medium, aiming to achieve the purpose of facilitating users to conveniently and accurately switch and try on multiple articles.

In a first aspect, an embodiment of the present disclosure provides a shoe try-on method based on AR (Augmented Reality), which includes:
in response to a triggering operation on collection controls correspondingly associated with at least two articles, adding the at least two articles to a collection list, the collection controls being displayed on a video playing page;
in response to a triggering operation of entering the collection list, starting a terminal camera, so as to enter a try-on page, a user target part shot by the camera being displayed in the try-on page; and
in response to a first triggering operation on a try-on control associated with a first article, wearing a first model of the first article on the target part, wherein the try-on control is displayed in the try-on page, and the first triggering operation is used for determining to select the first article from the at least two articles.

In a second aspect, an embodiment of the present disclosure also provides a data interaction apparatus, which includes:
a collection module, configured to in response to a triggering operation on collection controls correspondingly associated with at least two articles, add the at least two articles to a collection list, the collection controls being displayed on a video playing page;
a start module, configured to in response to a trigger operation of entering the collection list, start a terminal camera, so as to enter a try-on page, a user target part shot by the camera being displayed in the try-on page; and
a try-on module, configured to in response to a first triggering operation on a try-on control associated with the first article, wear a first model of the first article on the target part, wherein the try-on control is displayed in the try-on page, and the first triggering operation is used for determining to select the first article from the at least two articles.

In a third aspect, an embodiment of the present disclosure also provides an electronic device, which includes:
one or more processors; and
a storage apparatus for storing one or more programs;
wherein the one or more programs, when executed by the one or more processors, cause the one or more processors to implement the data interaction method as described above.

In a forth aspect, an embodiment of the present disclosure also provides a computer readable storage medium, storing a computer program thereon, wherein the program, when executed by a processor, implements the data interaction method as described above.

Compared with related technologies, the technical solution provided by the embodiment of the present disclosure at least has the following advantages:

The data interaction method according to the embodiment of the present disclosure includes: in response to a triggering operation on collection controls correspondingly associated with at least two articles, adding the at least two articles to a collection list, the collection controls being displayed on a video playing page; in response to a triggering operation of entering the collection list, starting a terminal camera, so as to enter a try-on page, a user target part shot by the camera being displayed in the try-on page; and in response to a first triggering operation on a try-on control associated with a first article, wearing a first model of the first article on the target part, the try-on control being displayed in the try-on page, and the first triggering operation being used for determining to select the first article from the at least two articles. It is supported to add the at least two articles to the collection list; the user can enter the try-on page from the collection list, and switch different articles collected in the collection list and try on respectively in the try-on page without exiting the try-on page, thus the operation path for the user switching and trying on the different articles is simplified, and the try-on efficiency and the user experience can be improved.

### BRIEF DESCRIPTION OF THE DRAWINGS

The above and other features, advantages, and aspects of each embodiment of the present disclosure will become more apparent in conjunction with the accompanying drawings and the following specific embodiments. In the accompanying drawings, identical or similar reference numerals represent identical or similar elements. It is to be understood that the accompanying drawings are illustrative, and the original and elements may not necessarily be drawn to scale.

FIG. 1 is a flowchart of a data interaction method according to an embodiment of the present disclosure;

FIG. 2 is an interface schematic diagram for displaying article associated information on a video playing picture according to an embodiment of the present disclosure;

FIG. 3 is a schematic diagram for displaying article associated information by means of a curved interface on a video playing picture according to an embodiment of the present disclosure;

FIG. 4 is a schematic diagram of a try-on page according to an embodiment of the present disclosure;

FIG. 5 is a schematic diagram of a try-on page according to an embodiment of the present disclosure;

FIG. 6 is a schematic diagram of a try-on page according to an embodiment of the present disclosure;

FIG. 7 is a process schematic diagram of a try-on method according to an embodiment of the present disclosure;

FIG. 8 is a recording process schematic diagram of a try-on process according to an embodiment of the present disclosure;

FIG. 9 is a structural schematic diagram of a data interaction apparatus according to an embodiment of the present disclosure; and

FIG. 10 is a structural schematic diagram of an electronic device according to an embodiment of the present disclosure.

### DETAILED DESCRIPTION

The embodiments of the present disclosure will be described in more detail below with reference to the accompanying drawings. Although some embodiments of the present disclosure are shown in the accompanying drawings, it is to be understood that the present disclosure may be implemented in various forms and may not be construed as limited to the embodiments described here. On the contrary, these embodiments are provided for a more thorough and complete understanding of the present disclosure. It is to be understood that the accompanying drawings and embodiments disclosed in the present disclosure are only for illustrative purposes and are not intended to limit the scope of protection of the present disclosure.

It is to be understood that the steps in embodiments of the present disclosure may be performed in different sequences, and performed in parallel. Further, the embodiments may include additional steps and/or omit to perform the illustrated steps. The scope of the present disclosure is not limited in this respect.

The term “including/comprising” and its variations as used herein mean openly including, i.e. “including but not limited to”. The term “based on” is “at least partially based on”. The term “one embodiment” means “at least one embodiment”; the term “another embodiment” means “at least one additional embodiment”; and the term “some embodiments” means “at least some embodiments”. Relevant definitions of other terms are given in the following description.

It is to be noted that the concepts of “first”, “second”, etc. mentioned in the present disclosure are only used for distinguishing different apparatuses, modules or units, and are not to limit the function performing sequence or interdependence of these apparatuses, modules or units.

It is to be noted that the modifications of “one” and “plurality” mentioned in the present disclosure are schematic rather than restrictive, and those skilled in the art should understand that unless otherwise expressly indicated in the context, it should be understood as “one or more”.

The names of messages or information interacted between a plurality of apparatuses in the embodiments of the present disclosure are for illustrative purposes only rather than for limitation to the scope of such messages or information.

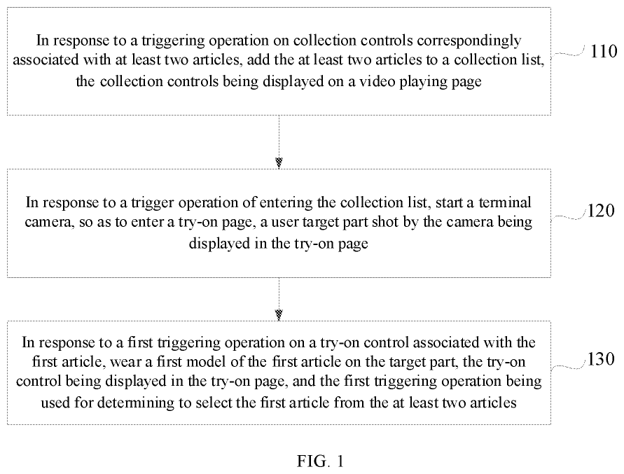

FIG. 1 is a flowchart of a data interaction method according to an embodiment of the present disclosure. The method may be executed by a data interaction apparatus; the apparatus may implement the method by means of software and/or hardware; and the apparatus may be configured in an electronic device, such as a display terminal, specifically including but being not limited to electronic devices with a display screen and a camera, such as a smart phone, a palm computer, a tablet computer, a portable wearable device, and a smart home device (like a table lamp).

As shown in FIG. 1, the method may include the following specific steps:

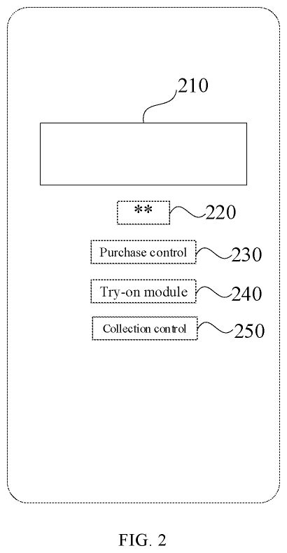

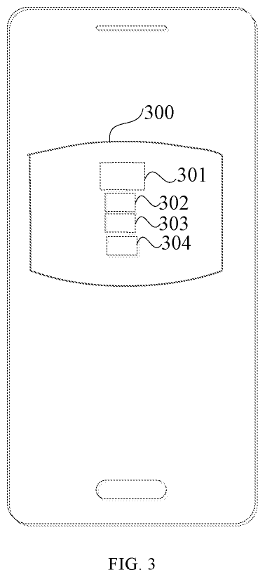

Step 110: In response to a triggering operation on collection controls correspondingly associated with at least two articles, add the at least two articles to a collection list, the collection controls being displayed on a video playing page.

Wherein the at least two articles refer to commodities sold by merchants, and may be clothes or shoes. A user can acquire a video which displays, introduces or tries on the at least two articles in a short-form video recommendation mode or a keyword searching mode. Associated information of each article is displayed on a playing picture of the video, as shown in FIG. 2 that is an interface schematic diagram for displaying article associated information on a video playing picture, it includes an image 210, price 220, a purchase control 230, a try-on control 240, a collection control 250 and the like of the articles. In the process that the user browses the video, if the user is interested in a certain article, the user may trigger the try-on control 240 to enter a try-on page, and try on the interested article in the try-on page. For example, the user tries on a pair of shoes; when the user triggers the try-on control 240 associated with the shoes, the terminal camera is started, the user aligns the lens with the feet, and meanwhile, the system controls the model of the shoes to be worn on the user's feet shot by the camera in real time, so that the AR try-on effect is achieved; the user can adjust the lens or adjust the foot postures to check the detail part of the shoe model, that is, the user's feet may move at will, and the shoe model always keeps the effect of being worn on the user's feet along with movement of the feet. In order to obtain good visual feeling and shopping immersion, article associated information may be displayed by means of a curved surface interface in a video playing picture, as shown in FIG. 3 that is a schematic diagram for displaying article associated information by means of a curved interface on a video playing picture, it includes a curved surface interface 300; the article associated information is displayed in the curved surface interface 300, and the article associated information may specifically be an image 301 of the shoes, a try-on control 302 associated with the image 301 of the shoes, a collection control 303, and a purchase control 304; and the user can trigger the try-on control 302 to enter the try-on page of the shoes represented by the image 301. The user can screen left or right to switch the list of shoes and browse shoes of other styles.

When entering the try-on page of a certain article in the process of browsing a video, the user can only try on this article; if the user wants to try on other articles, it is needed to return to the playing page of the video from the try-on page, and then enter the try-on page of the other articles through the try-on control associated with other articles displayed in the playing page of the video, and the operation is tedious. For the problem, in this try-on solution provided by the embodiment of the present disclosure, it is supported to add articles to the collection list, namely, if the user is interested in some articles while browsing the video, the user can add the interested articles to the collection list, and then enter the try-on page from the collection list; the user can conveniently switch in the try-on page to try on each article, and it is not needed to exit the try-on page when switching the articles, so the purpose of shortening the try-on operation path is achieved, and the try-on experience of the user can be improved.

Specifically, if the user is interested in a certain article while browsing a video, the user can trigger the collection control associated with the article, so as to achieve the purpose of adding the article to the collection list. Generally, it is the step of in response to the triggering operation on collection controls correspondingly associated with the at least two articles, adding the at least two articles to the collection list, the collection controls being displayed on the video playing page.

Step 120: In response to a triggering operation of entering the collection list, start a terminal camera, so as to enter a try-on page, a user target part shot by the camera being displayed in the try-on page.

Wherein the triggering operation of entering the collection list may be an operation of entering a “my” page through a “my” tag of a video application and clicking the “collection list” on the “my” page, and may also be an operation of triggered on a home page of the video application, such as an operation of left or right swiping the home page (namely the playing page of the video) of the video application.

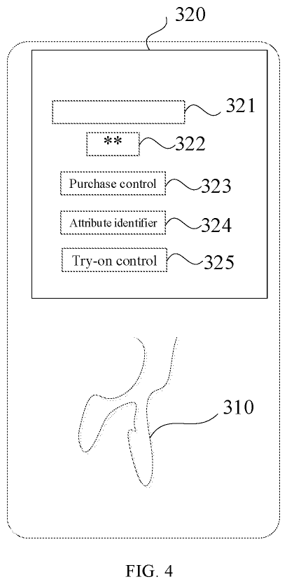

The try-on page is actually a shooting page of the camera, and the try-on page not only displays the real-time shooting picture, but also displays the associated information of the articles added in the collection list. For example, as shown in FIG. 4 that is a schematic diagram of a try-on page, it includes a user target part 310 shot in real time by the camera, and associated information 320 of a first article. The associated information 320 includes an image 321, price 322, a purchase control 323, an attribute identifier 324 and a try-on control 325 of the first article.

Step 130: In response to a first triggering operation on a try-on control associated with a first article, wear a first model of the first article on the target part, wherein the try-on control is displayed in the try-on page, and the first triggering operation is used for determining to select the first article from the at least two articles.

Specifically, when the user triggers the try-on control 325, the first model of the first article will be worn on the shot target part of the user to realize AR try-on. The first model of the first article may be a first model with a preset size or a preset color, for example, the first article is male shoes, the first model may be a model corresponding to the size of a large number of purchasers, for example, a 42-size model; and if the first article is female shoes, the first model may be a 37-size model. If the first article has a plurality of colors for choosing, the first model may be a model corresponding to a salable color. In the try-on process, the user may randomly switch the size, the color and the like of the first article for trying on. Specifically, in response to a triggering operation on the attribute identifier 324 associated with the first article, a second model of the first article matched with the attribute identifier 324 is used for replacing the first model to be worn on the target part. The attribute identifier 324 may be a size identifier or a color identifier. When the user clicks a specific size identifier, the model matched with the triggered size identifier is used for replacing the model worn on the target part. For example, the first article is the male shoes, the user can trigger the try-on control 325 to wear the 42-size shoe model on the feet; if the user feels that it is too small and is not suitable for the feet, the user may trigger the 43-size identifier; after the 43-size identifier is triggered, the 43-size shoe model will replace the 42-size shoe model to be worn on the user's feet, and the 43-size shoe model is larger than the 42-size shoe model. The user may also switch the colors, for example, if the shoe model worn on the user's feet is white, and the user wants to try on black, the user can trigger a black identifier to replace the white shoe model with the black shoe model on the feet, so that the white shoes can be tried on. When trying on, it seems like the shoes are actually worn on the user's feet, so the user has an immersion feeling of actually trying on the shoes, and the user can conveniently view the actual trying-on effect. Specifically, the shoe model refers to a three-dimensional model of the shoes; the three-dimensional model of the shoes may be stored in a server in a form of a file package; and when a client needs to call the three-dimensional model of the shoes, the corresponding three-dimensional model is acquired from the server. In some embodiments, in order to realize the virtual try-on function at the client, the file package including the three-dimensional model of the shoes is pre-stored in the server working in cooperation with the client; the file package may further include at least one of the following resources: a map sub-file of the shoes, a model sub-file of the shoes, a material resource file, a shank model, a rendering assembly, a pose assembly, and a reference relationship between the rendering component and each file, for example, the material resource file references the map sub-file, the rendering assembly references the model sub-file and the material resource file, and the pose assembly references a foot detection algorithm, thus the server cooperates with the client to realize the virtual try-on function at the client based on the file package. Specifically, when the client performs virtual try-on, the foot position and pose of the user may be acquired in real time through the pose assembly, and the rendering assembly renders the three-dimensional model of the shoes according to the foot position and pose of the user.

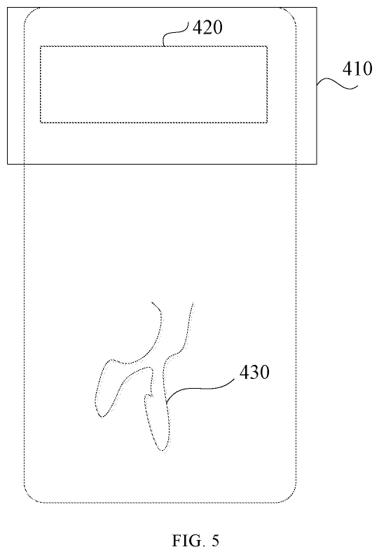

In the try-on page, the user can conveniently switch the size, color and the like of the same article to try on, and can also conveniently switch different articles to try on. In one embodiment, in response to a preset operation on a preset area in the try-on page, the associated information of a second article is displayed by means of a curved surface interface in the preset area, and the preset operation is used for determining the selected second article from the at least two articles. The preset operation may be a left and right swiping operation. The associated information of the second article includes at least one of the following: an image of the second article, value information of the second article, a try-on control of the second article, and an acquisition control of the second article. Exemplary, as shown in FIG. 5 that is a schematic diagram of a try-on page, associated information 420 of the second article is displayed in a preset area 410 in the try-on page; when the user left or right swipes the preset area 410, the article information displayed in the preset area 410 may be switched; and the try-on page further includes a user target part 430 shot in real time through the camera. The user can trigger the try-on control associated with the second article to try on the second article, that is, the system controls the model of the second article to be worn on the user target part. When the user switches the tried-on article, it is not needed to exit the try-on page, or close the camera, the user can trigger the try-on control associated with other articles in the try-on page to realize the try-on of other articles, and thus the user can conveniently switch and try on different articles, and the user can conveniently compare the try-on effects.

Further, if the user is relatively satisfied with the first article and wants to purchase it after try-on, the user can trigger a purchase control which is displayed in the try-on page and associated with the first article to purchase it; by setting the purchase control in the try-on page, the user can directly purchase the first article after try-on, and it is not needed to exit the try-on page to find out a purchase entrance, so that the purchase operation of the user is simplified, and the usage experience of the user can be improved. Exemplarily, the try-on method further includes: in response to a triggering operation on an acquisition control associated with the first article, displaying an acquisition page of the first article, thereby enabling the user to acquire the first article based on the acquisition page, the acquisition control being displayed in the try-on page.

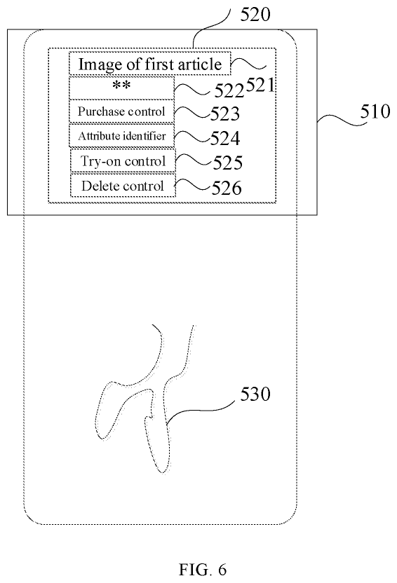

Correspondingly, if the user does not like the article after try-on, the user may remove the article from the collection list preferentially in order to avoid interference of this article on the choice of the user. As shown in FIG. 6 that is a schematic diagram of a try-on page, associated information 520 of the first article is displayed in a preset area 510 in the try-on page, and the associated information 520 includes an image 521, price 522, a purchase control 523, an attribute identifier 524, a try-on control 525 and a deletion control 526 of the first article; and the try-on page further includes a user target part 530 shot in real time through the camera. In response to a triggering operation on the deletion control 526 associated with the first article, the first article is controlled to be removed from the collection list; after the first article is removed, the user cannot find out the associated information of the first article any more when left or right swiping in the preset area 510 in the try-on page; and in other words, the articles switched and displayed in the preset area 510 are the articles added in the collection list, and the articles not added in the collection list are not displayed in the preset area 510 any more.

In one embodiment, the try-on method further includes: in response to a target operation, starting a terminal screen recording function to record a terminal screen so as to obtain a recorded video; and in response to a triggering operation on a release control, releasing the recorded video as a work, so as to be seen by more users, thereby realizing secondary propagation, achieving the purpose of popularizing the recorded article, or helping other users to be familiar with an AR try-on interaction process, and exciting other users to try on. Specifically, when the recorded video is played on other user terminals, the video picture will display the “try-on control”, and other users can trigger the “try-on control” to enter the try-on page.

Wherein the target operation may be an operation of triggering a screen recording control, and may also be other operations, such as a triggering operation on the try-on control and/or a triggering operation on the collection control. If the target operation is the triggering operation on the try-on control, namely, if the user triggers the try-on control and starts screen recording, the try-on effect of the user and the interaction behaviors such as switching articles, sizes or colors in the try-on process are recorded to obtain the recorded video. The triggering condition of ending the recording may be an operation of triggering an end control by the user, and may also be an operation of exiting from the try-on page, for example, if the user triggers the purchase control to purchase the article, the recording will be stopped. Generally, after the terminal screen recording function is started, the method further includes: in response to a triggering operation on an acquisition control, closing the terminal screen recording function, so as to stop the recording of a terminal screen. After the recording is ended, a release control may be displayed to guide the user to release the recorded video as a work, for example, the user can be prompted in a bubble form to release the recorded video.

According to the data interaction method provided by the embodiment of the present disclosure, the user can conveniently switch and try on a plurality of different articles, the operation path and the operation complexity during the switching and try-on process are simplified, and the immersion effect like trying-on in a physical store can be achieved. Meanwhile, the articles can be purchased in the try-on page, the purchase path is simplified, and the usage experience of the user can be improved. By recording and sharing the try-on process, a secondary propagation link is provided.

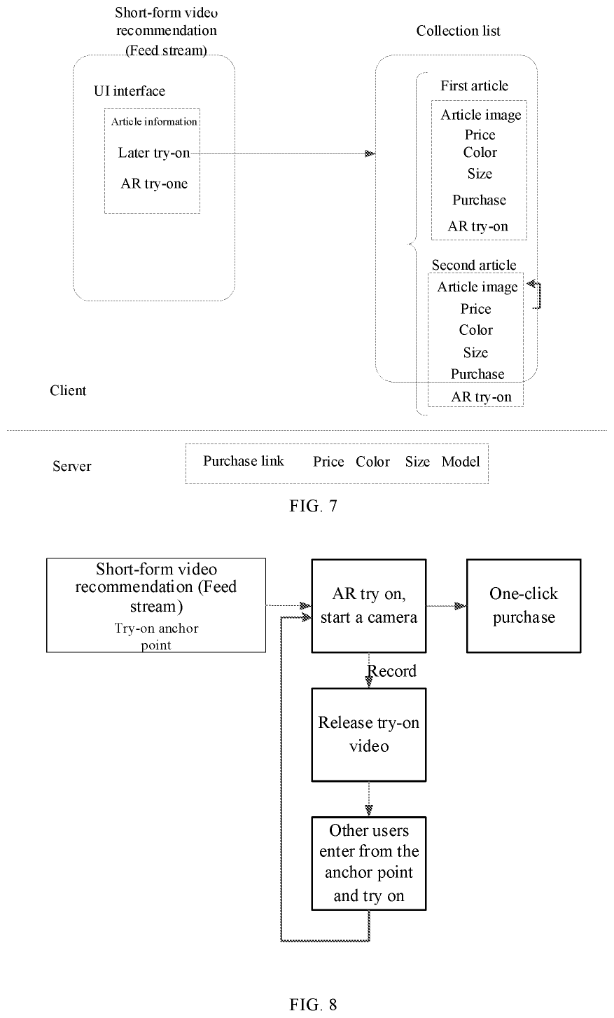

On the basis of the embodiment above, as shown in FIG. 7 that is a process schematic diagram of a try-on method, the article information (such as article images, prices, and purchase links), a later try-on control (namely the collection control), and the AR try-on control are displayed in the playing page of the article recommendation video, and the user can trigger the AR try-on control to enter the try-on page, and can trigger the later try-on control to add the article to the collection list. The added article information (including images, prices, colors, sizes, AR try-on controls, and purchase controls) is sequentially displayed in the collection list, and the user can enter the collection list to switch and try on all the added articles; a server will control the model of the articles to be distributed to the client in the try-on process, and then the client renders the model to the shot target part of the user.

As shown in FIG. 8 that is a recording process schematic diagram of a try-on process, the article information and a try-on anchor point (namely the try-on control) are displayed in the video page; when the user triggers the try-on control, the camera will be started, and the screen recording function will be started at the same time; the user can release the recorded video; and other users can enter the try-on page through the try-on control displayed in the playing page of the recorded video when browsing the recorded video.

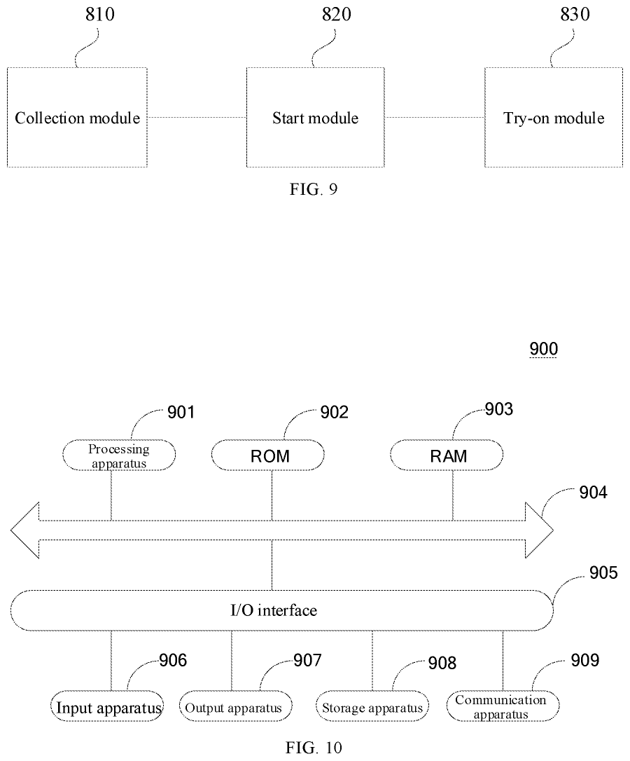

FIG. 9 is a structural schematic diagram of a data interaction apparatus according to an embodiment of the present disclosure. As shown in FIG. 9, the data interaction apparatus specifically includes: a collection module 810, a start module 820, and a try-on module 830.

Wherein the collection module 801 is configured to in response to a triggering operation on collection controls correspondingly associated with at least two articles, add the at least two articles to a collection list, the collection controls being displayed on a video playing page; the start module 820 is configured to in response to a trigger operation of entering the collection list, start a terminal camera, so as to enter a try-on page, a user target part shot by the camera being displayed in the try-on page; and the try-on module 830 is configured to in response to a first triggering operation on a try-on control associated with the first article, wear a first model of the first article on the target part, wherein the try-on control is displayed in the try-on page, and the first triggering operation is used for determining to select the first article from the at least two articles.

Optionally, the apparatus further includes: an acquisition module, configured to in response to a triggering operation on an acquisition control associated with the first article, display an acquisition page of the first article, thereby enabling the user to acquire the first article based on the acquisition page, the acquisition control being displayed in the try-on page.

Optionally, the apparatus further includes: a switching module, configured to in response to a triggering operation on an attribute identifier associated with the first article, utilize a second model of the first article matched with the attribute identifier to replace the first model to be worn on the target part.

Optionally, the apparatus further includes: a display module, configured to in response to a preset operation on a preset area in the try-on page, display the associated information of a second article by means of a curved surface interface in the preset area, the preset operation being used for determining the selected second article from the at least two articles.

Optionally, the associated information of the second article includes at least one of the following:
an image of the second article, value information of the second article, a try-on control of the second article, and an acquisition control of the second article.

Optionally, the apparatus further includes: a removal module, configured to in response to a triggering operation on a deletion control associated with the first article, control the first article to be removed from the collection list.

Optionally, the apparatus further includes: a recording module, configured to in response to a target operation, start a terminal screen recording function to record a terminal screen so as to obtain a recorded video, and in response to the triggering operation on the acquisition control, close the terminal screen recording function, so as to stop the recording of the terminal screen; and a releasing module, configured to in response to a triggering operation on a release control, release the recorded video as a work.

Optionally, the target operation includes: a triggering operation on the try-on control and/or a triggering operation on the collection control.

Optionally, the apparatus further includes: a skip module, configured to in response to the triggering operation on the try-on control in the recorded video, enter the try-on page of an associated article.

According to the data interaction apparatus provided by the embodiment of the present disclosure, the user can conveniently switch and try on a plurality of different articles, the operation path and the operation complexity during the switching and try-on process are simplified, and the immersion effect like trying-on in a physical store can be achieved. Meanwhile, the articles can be purchased in the try-on page, the purchase path is simplified, and the usage experience of the user can be improved. By recording and sharing the try-on process, a secondary propagation link is provided.

The data interaction apparatus according to the embodiment of the present disclosure can be used for implementing the steps in the data interaction method according to the embodiment of the present disclosure, and the implementing steps and the beneficial effects are not described any more herein.

FIG. 10 is a structural schematic diagram of an electronic device according to an embodiment of the present disclosure. FIG. 10 shows a structural schematic diagram suitable for realizing the electronic device 900 according to an embodiment of the present disclosure. The electronic device 900 according to the embodiment of the present disclosure may include but be not limited to mobile terminals such as mobile terminals like mobile phones, notebook computers, digital broadcast receivers, PDAs (Personal Digital Assistants), PADs (Tablet Personal Computers), PMPs (Portable Multimedia Players), vehicle-mounted terminals (such as vehicle-mounted navigation terminals), and wearable electronic devices, and fixed terminals like digital TVs, desktop computers, and smart home devices. The electronic device shown in FIG. 10 is only an example and should not impose any limitations on the functionality or scope of use of the embodiment of the present disclosure.

As shown in FIG. 10, the electronic device 900 may include a processing apparatus (such as a central processing unit, and a graphic processor) 901, and the processing device may execute various proper actions and processing according to programs stored in a Read-Only Memory (ROM) 902 or programs loaded into a Random Access Memory (RAM) 903 from a storage apparatus 908 so as to achieve the method according to the embodiment of the present disclosure. Various programs and data for the operation of the electronic apparatus 900 are further stored in the RAM 903. The processing apparatuses 901, the ROM 902 and the RAM 903 are interconnected through a bus 904. An input/output (I/O) interface 905 is also connected to the bus 904.

Generally, the following apparatuses may be connected to an I/O interface 905: an input apparatus 906 including a touch screen, a touch pad, a keyboard, a mouse, a camera, a microphone, an accelerometer, a gyroscope and the like, an output apparatus 907 including a liquid crystal display (LCD), a loudspeaker, a vibrator and the like, a storage device 908 including a magnetic tape, a hard disk and the like, and a communication apparatus 909. The communication apparatus 909 may allow the electronic device 900 to perform wireless or wired communication with other devices to exchange data. Although FIG. 10 illustrates the electronic device 900 with various apparatuses, it is to be understood that it is not required to implement or provide all the shown apparatuses. More or fewer devices can be alternatively implemented or provided.

Particularly, according to the embodiment of the present disclosure, the above process described with reference to the flowchart may be implemented as a computer software program. For example, an embodiment of the present disclosure includes a computer program product which includes a computer program loaded on a non-transient computer readable medium, the computer program including a program code for executing the method shown by the flowchart, so that the above method is implemented. In this embodiment, the computer program may be downloaded and installed from a network through the communication apparatus 909, or installed from the storage apparatus 908, or installed from the ROM 902. When the computer program is executed by the processing apparatus 901, the above functions defined in the method according to the embodiment of the present disclosure are executed.

It is to be noted that a computer readable medium according to the present disclosure may be a computer readable signal medium or a computer readable storage medium or any combination of the two. The computer readable storage medium may be, for example, but not limited to, an electrical, magnetic, optical, electromagnetic, infrared, or semiconductor system, apparatus or device, or any combination of the above. More specific examples of computer readable storage media may include, but are not limited to, electrical connectors having one or more conductors, a portable computer disk, a hard disk, a Random Access Memory (RAM), a Read-Only Memory (ROM), an Erasable Programmable Read-Only Memory (EPROM or flash memory), an optical fiber, a portable Compact Disk Read-Only Memory (CD-ROM), an optical storage device, a magnetic storage device, or any suitable combination of the above. In the present disclosure, the computer readable storage medium may be any tangible medium containing or storing a program that may be used by or in combination with an instruction execution system, apparatus or device. In the present disclosure, the computer readable signal medium may include a data signal that propagates in a baseband or as part of a carrier, and the data signal carries computer readable program code. The propagated data signal may take a variety of forms, including, but being not limited to, an electromagnetic signal, an optical signal, or any suitable combination of the above. The computer readable signal medium may also be any computer readable medium other than a computer readable storage medium that may send, propagate, or transmit a program for use by or in combination with an instruction execution system, apparatus or device. The program code in on the computer readable medium may be transmitted with any suitable medium, including, but being not limited to, an electrical wire, an optical cable, an RF (radio frequency) or the like, or any suitable combination of the above.

In some embodiments, the client, and the server may communicate using any currently known or future developed network Protocol, such as HTTP (HyperText Transfer Protocol), and may interconnect with digital data communications (e.g., communication networks) of any form or medium. Examples of communication networks include local area networks (“LANs”), wide area networks (“WANs”), Internet networks (e.g., the Internet) and end-to-end networks (e.g., ad hoc end-to-end networks), and any currently known or future developed network.

The abovementioned computer readable medium may be contained in the electronic device, and may also exist independently without being assembled in the electronic device.

The abovementioned computer readable medium carries one or more programs, and the one or more programs, when executed by the electronic device, cause the electronic device to:
in response to a triggering operation on collection controls correspondingly associated with at least two articles, add the at least two articles to a collection list, the collection controls being displayed on a video playing page; in response to a triggering operation of entering the collection list, start a terminal camera, so as to enter a try-on page, a user target part shot by the camera being displayed in the try-on page; and in response to a first triggering operation on a try-on control associated with a first article, wear a first model of the first article on the target part, wherein the try-on control is displayed in the try-on page, and the first triggering operation is used for determining to select the first article from the at least two articles.

Optionally, when one or more programs are executed by the electronic device, the electronic device can also execute other steps described in the above embodiment.

The computer program code for executing the operations of the present disclosure may be written in one or more programming languages or a combination thereof, the programming languages including, but being not limited to object-oriented programming languages such as Java, Smalltalk and C++, and also including conventional process programming languages such as a “C” language or similar programming languages. The program code may be completely executed on a user computer, partially executed on the user computer, executed as a separate software package, partially executed on the user computer, partially executed on a remote computer, or completely executed on the remote computer or a server. In a case involving the remote computer, the remote computer may be connected to the user computer through any kind of networks including a Local Area Network (LAN) or a Wide Area Network (WAN), or may be connected to an external computer (for example, the remote computer is connected through the Internet by utilizing an Internet service provider).

The flowchart and the block diagram in the accompanying drawings illustrate the architecture, functions and operations which can be possibly realized according to the systems, methods and computer program products according to various embodiments of the present disclosure. In this regard, each block in the flowchart or the block diagram may represent a module, a program segment or a part of code; and the module, the program segment or the part of code contains one or more executable instructions for realizing specified logic functions. It is to be noted that in some alternative embodiments, the functions marked in the blocks may also occur in a different order than the order marked in the accompanying drawing. For example, two blocks represented in succession may be executed substantially in parallel, and sometimes may also be executed in an opposite order depending on the functions involved. It is also to be noted that each block in the block diagram and/or the flowchart and the combination of the blocks in the block diagram and/or the flowchart may be implemented by a dedicated hardware-based system for executing specified functions or operations, or may be implemented by a combination of dedicated hardware and computer instructions.

The unit described in the embodiment of the present disclosure may be implemented in a software manner, and may also be implemented in a hardware manner. The name of the unit does not form the limitation of the unit in a certain case.

The above functions according to the present disclosure may be at least partially executed by one or more hardware logic components. For example, the hardware logic components of the demonstration type that may be used in a non-limiting manner includes: a Field Programmable Gate Array (FPGA), an Application Specific Integrated Circuit (ASIC), an Application Specific Standard Product (ASSP), a System On Chip (SOC), a Complex Programmable Logic Device (CPLD) and the like.

In the context of the present disclosure, a machine readable medium may be a tangible medium, and may contain or store a program used by the instruction execution system, apparatus or device or used in combination with the instruction execution system, apparatus or device. The machine readable medium may be a machine readable signal medium or a machine readable storage medium. The machine readable medium may include but be not limited to electronic, magnetic, optical, electromagnetic, infrared or semiconductor systems, apparatuses or devices, or any proper combination of the above contents. More specific examples of the machine readable storage medium may include one or more wire-based electrical connection, a portable computer disk, a hard disk, a Random Access Memory (RAM), a Read-Only Memory (ROM), an Erasable Programmable Read-Only Memory (EPROM or flash memory), an optical fiber, a Compact Disk-Readable Memory (CD-ROM), an optical storage device, a magnetic storage device, or any proper combination of the above contents.

According to one or more embodiments of the present disclosure, the present disclosure provides a data interaction method, including: in response to a triggering operation on collection controls correspondingly associated with at least two articles, adding the at least two articles to a collection list, the collection controls being displayed on a video playing page; in response to a triggering operation of entering the collection list, starting a terminal camera, so as to enter a try-on page, a user target part shot by the camera being displayed in the try-on page; and in response to a first triggering operation on a try-on control associated with a first article, wearing a first model of the first article on the target part, wherein the try-on control is displayed in the try-on page, and the first triggering operation is used for determining to select the first article from the at least two articles.

According to one or more embodiments of the present disclosure, optionally, the data interaction method provided by the present disclosure further includes: in response to a triggering operation on an acquisition control associated with the first article, displaying an acquisition page of the first article, thereby enabling the user to acquire the first article based on the acquisition page, the acquisition control being displayed in the try-on page.

According to one or more embodiments of the present disclosure, optionally, the data interaction method provided by the present disclosure further includes: in response to a triggering operation on an attribute identifier associated with the first article, utilizing a second model of the first article matched with the attribute identifier to replace the first model to be worn on the target part.

According to one or more embodiments of the present disclosure, optionally, the data interaction method provided by the present disclosure further includes: in response to a preset operation on a preset area in the try-on page, displaying the associated information of a second article by means of a curved surface interface in the preset area, the preset operation being used for determining the selected second article from the at least two articles.

According to one or more embodiments of the present disclosure, optionally, in the data interaction method provided by the present disclosure, the associated information of the second article includes at least one of the following: an image of the second article, value information of the second article, a try-on control of the second article, and an acquisition control of the second article.

According to one or more embodiments of the present disclosure, optionally, the data interaction method provided by the present disclosure further includes: in response to a target operation, starting a terminal screen recording function to record a terminal screen so as to obtain a recorded video; and in response to a triggering operation on a release control, releasing the recorded video as a work.

According to one or more embodiments of the present disclosure, optionally, in the data interaction method provided by the present disclosure, the target operation includes a triggering operation on the try-on control and/or a triggering operation on the collection control.

According to one or more embodiments of the present disclosure, optionally, in the data interaction method provided by the present disclosure, the recorded video includes the try-on control; and the method further includes: in response to a triggering operation on the try-on control in the recorded video, entering the try-on page of an associated article.

According to one or more embodiments of the present disclosure, optionally, in the data interaction method provided by the present disclosure, after the terminal screen recording function is started, the method further includes: in response to a triggering operation on an acquisition control, closing the terminal screen recording function, so as to stop the recording of a terminal screen.

According to one or more embodiments of the present disclosure, the present disclosure provides a data interaction apparatus, including: a collection module, configured to in response to a triggering operation on collection controls correspondingly associated with at least two articles, add the at least two articles to a collection list, the collection controls being displayed on a video playing page; a start module, configured to in response to a trigger operation of entering the collection list, start a terminal camera, so as to enter a try-on page, a user target part shot by the camera being displayed in the try-on page; and a try-on module, configured to in response to a first triggering operation on a try-on control associated with the first article, wear a first model of the first article on the target part, the try-on control being displayed in the try-on page, and the first triggering operation being used for determining to select the first article from the at least two articles.

According to one or more embodiments of the present disclosure, optionally, the data interaction apparatus provided by the present disclosure further includes: an acquisition module, configured to in response to a triggering operation on an acquisition control associated with the first article, display an acquisition page of the first article, thereby enabling the user to acquire the first article based on the acquisition page, the acquisition control being displayed in the try-on page.

According to one or more embodiments of the present disclosure, optionally, the data interaction apparatus provided by the present disclosure further includes: a switching module, configured to in response to a triggering operation on an attribute identifier associated with the first article, utilize a second model of the first article matched with the attribute identifier to replace the first model to be worn on the target part.

According to one or more embodiments of the present disclosure, optionally, the data interaction apparatus provided by the present disclosure further includes: a display module, configured to in response to a preset operation on a preset area in the try-on page, display the associated information of a second article by means of a curved surface interface in the preset area, the preset operation being used for determining the selected second article from the at least two articles.

According to one or more embodiments of the present disclosure, optionally, in the data interaction apparatus provided by the present disclosure, the associated information of the second article includes at least one of the following: an image of the second article, value information of the second article, a try-on control of the second article, and an acquisition control of the second article.

According to one or more embodiments of the present disclosure, optionally, the data interaction apparatus provided by the present disclosure further includes: a removal module, configured to in response to a triggering operation on a deletion control associated with the first article, control the first article to be removed from the collection list.

According to one or more embodiments of the present disclosure, optionally, the data interaction apparatus provided by the present disclosure further includes: a recording module, configured to in response to a target operation, start a terminal screen recording function to record a terminal screen so as to obtain a recorded video, and in response to the triggering operation on the acquisition control, close the terminal screen recording function, so as to stop the recording of the terminal screen; and a releasing module, configured to in response to a triggering operation on a release control, release the recorded video as a work.

According to one or more embodiments of the present disclosure, optionally, in the data interaction apparatus provided by the present disclosure, the target operation includes a triggering operation on the try-on control and/or a triggering operation on the collection control.

According to one or more embodiments of the present disclosure, optionally, the data interaction apparatus provided by the present disclosure further includes: a skip module, configured to in response to the triggering operation on the try-on control in the recorded video, enter the try-on page of an associated article.

According to one or more embodiments of the present disclosure, the present disclosure provides an electronic device, including:
one or more processors; and
a memory for storing one or more programs;
wherein the one or more programs, when executed by the one or more processors, cause the one or more processors to implement any one of the data interaction methods according to the present disclosure.

According to one or more embodiments of the present disclosure, the present disclosure provides a computer readable storage medium, storing a computer program thereon, wherein the program, when executed by a processor, implement any one of the abovementioned data interaction methods according to the present disclosure.

An embodiment of the present disclosure further provides a computer program product, which includes a computer program or instructions, and the computer program or instructions, when executed by a processor, implement the data interaction method as described above.

The above description is only a preferred embodiment of the present disclosure and an explanation of the technical principles used. Those skilled in the art should understand that the scope of disclosure referred to in the present disclosure is not limited to technical solutions formed by specific combinations of the aforementioned technical features, but also covers other technical solutions formed by arbitrary combinations of the aforementioned technical features or their equivalent features without departing from the aforementioned disclosed concept. For example, a technical solution formed by replacing the above features with (but not limited to) technical features with similar functions disclosed in the present disclosure.

Moreover, although each operation is depicted in a specific order, this should not be understood as requiring them to be executed in the specific order shown or in a sequential order. In certain environments, multitasking and parallel processing may be advantageous. Similarly, although several specific implementation details are included in the above discussion, these should not be interpreted as limiting the scope of the present disclosure. Some features described in the context of individual embodiments can also be combined and implemented in a single embodiment. On the contrary, various features described in the context of a single embodiment can also be implemented individually or in any suitable sub combination in multiple embodiments.

Although the subject matter has been described in language specific to structural features and/or method logical actions, it should be understood that the subject matter limited in the attached claims may not necessarily be limited to the specific features or actions described above. On the contrary, the specific features and actions described above are only exemplary forms of implementing the claims.

1. A data interaction method, comprising:
in response to a triggering operation on collection controls correspondingly associated with at least two articles, adding the at least two articles to a collection list, the collection controls being displayed on a video playing page;
in response to a triggering operation of entering the collection list, starting a terminal camera, so as to enter a try-on page, a user target part shot by the camera being displayed in the try-on page; and
in response to a first triggering operation on a try-on control associated with a first article, wearing a first model of the first article on the target part, wherein the try-on control is displayed in the try-on page, and the first triggering operation is used for determining to select the first article from the at least two articles.

2. The method according to claim 1, further comprising:
in response to a triggering operation on an acquisition control associated with the first article, displaying an acquisition page of the first article, thereby enabling the user to acquire the first article based on the acquisition page, the acquisition control being displayed in the try-on page.

3. The method according to claim 1, further comprising:
in response to a triggering operation on an attribute identifier associated with the first article, utilizing a second model of the first article matched with the attribute identifier to replace the first model to be worn on the target part.

4. The method according to claim 1, further comprising:
in response to a preset operation on a preset area in the try-on page, displaying the associated information of a second article by means of a curved surface interface in the preset area, the preset operation being used for determining the selected second article from the at least two articles.

5. The method according to claim 4, wherein the associated information of the second article comprises at least one of the following:
an image of the second article, value information of the second article, a try-on control of the second article, and an acquisition control of the second article.

6. The method according to claim 1, further comprising:
in response to a triggering operation on a deletion control associated with the first article, controlling the first article to be removed from the collection list.

7. The method according to claim 1, further comprising:
in response to a target operation, starting a terminal screen recording function to record a terminal screen so as to obtain a recorded video; and
in response to a triggering operation on a release control, releasing the recorded video as a work.

8. The method according to claim 7, wherein the target operation comprises a triggering operation on the try-on control and/or a triggering operation on the collection control.

9. The method according to claim 7, wherein the recorded video comprises the try-on control; and the method further comprises:
in response to a triggering operation on the try-on control in the recorded video, entering the try-on page of an associated article.

10. The method according to claim 7, wherein after the terminal screen recording function is started, and the method further comprises:
in response to a triggering operation on an acquisition control, closing the terminal screen recording function, so as to stop the recording of a terminal screen.

11. A data interaction apparatus, comprising:
a collection module, configured to in response to a triggering operation on collection controls correspondingly associated with at least two articles, add the at least two articles to a collection list, the collection controls being displayed on a video playing page;
a start module, configured to in response to a trigger operation of entering the collection list, start a terminal camera, so as to enter a try-on page, a user target part shot by the camera being displayed in the try-on page; and
a try-on module, configured to in response to a first triggering operation on a try-on control associated with the first article, wear a first model of the first article on the target part, wherein the try-on control is displayed in the try-on page, and the first triggering operation is used for determining to select the first article from the at least two articles.

12. An electronic device, comprising:
one or more processors; and
a storage apparatus for storing one or more programs;
wherein the one or more programs, when executed by the one or more processors, cause the one or more processors to implement a data interaction method, comprising:
in response to a triggering operation on collection controls correspondingly associated with at least two articles, adding the at least two articles to a collection list, the collection controls being displayed on a video playing page;
in response to a triggering operation of entering the collection list, starting a terminal camera, so as to enter a try-on page, a user target part shot by the camera being displayed in the try-on page; and
in response to a first triggering operation on a try-on control associated with a first article, wearing a first model of the first article on the target part, wherein the try-on control is displayed in the try-on page, and the first triggering operation is used for determining to select the first article from the at least two articles.

13. A non-transient computer readable storage medium, storing a computer program thereon, wherein the program, when executed by at least one processor, implements the method according to claim 1.
